(19) United States
(12) Patent Application Publication
(10) Pub. No.: US 2008/0283581 A1
(43) Pub. Date: Nov. 20, 2008

(54) Apparatus and method for connecting copper tubes

(75) Inventor: Chang Duk Jeon, Chungju-Si (KR)

Correspondence Address: Peter T. Kwon, Gwacheon P. O. Box 72, Gwacheon City, Gyeonggi-Do, 427-600, KR

(73) Assignees: Chungju National University; Industry-Academic Cooperation Foundation

(21) Appl. No.: 12/153,398

(22) Filed: May 19, 2008

(30) Foreign Application Priority Data
May 17, 2007 (KR) 10-2007-0047945
May 9, 2008 (KR) 10-2008-0043391

(51) Int. Cl. F16L 21/08; B23K 31/02; F16L 21/00

(52) U.S. Cl. 228/189; 285/294.1; 285/369

(57) ABSTRACT

An apparatus and method for connecting copper tubes are developed to facilitate welding operation in the refrigerating device. The new apparatus will reduce the poor welding rate so that it will effectively prevent clogging of the copper tubes and leaking the refrigerant. It also has merit to easily determine a suitable heating time while the copper tubes are welding. Thus, the rate of poor welding is reduced, as well as a method for connecting copper tubes by using the tube connecting apparatus.

### BACKGROUND OF THE INVENTION

1. Field of the Invention

The present invention relates to an apparatus and method for connecting copper tubes in a refrigerating system. More particularly, the apparatus facilitates to weld the copper tubes in the refrigeration device for preventing the clogging of the tubes and leaking the refrigerant due to the improper welding. While the copper tubes are welding, a suitable pre-heating and welding times are easily determined for reducing the rate of poor welding.

2. Related Prior Art

As generally known in the art, refrigeration devices have the following refrigeration cycle: the refrigerant flows through a compressor, a condenser, a capillary tube (a copper tube), an evaporator, and a suction tube. Then, the refrigerant again flows into the compressor. Refrigeration devices based on such a refrigeration cycle include refrigerators, air conditioners, etc.

Such refrigeration devices require a connection between the capillary tube, which has a smaller diameter, and a tube having a larger diameter (e.g. evaporator suction tube). In this regard, it is crucial to connect the capillary tube to another tube without poor welding, which would otherwise cause the refrigerant to leak out or clog the capillary tube.

A conventional capillary tube connecting device for accomplishing the above-mentioned task is disclosed in Korean Utility Model Application No. 20-1997-0035044 (filed Nov. 29, 1997), entitled “Refrigeration Machine Assembly Structure For Refrigerator”. As shown in FIG. 3, the outlet-side end of a capillary tube T and the inlet-side end of a suction tube S are inserted into the inlet-side and outlet-side ends of a refrigeration machine E, respectively, up to a predetermined length. Then, both ends of the refrigeration machine E are welded to the outer peripheries of the capillary tube T and the suction tube S, respectively, so that they are connected integrally.

Another conventional capillary tube connecting device is disclosed in Korean Utility Model Application No. 20-1998-0018760 (filed Sep. 30, 1998), entitled “Refrigerator Dryer Easily Coupled to Capillary Tube”. As shown in FIG. 1, the section of the coupling portion 11, to which a capillary tube 20 is coupled, is processed to have an inward slant so that, when the dryer 10 and the capillary tube 20 are coupled to each other, the melted welding material 30 flows through the resulting groove 13.

FIGS. 1a and 1b briefly show a configuration common to the above-mentioned conventional devices. Referring to FIG. 1a, a capillary tube 10, which has a small outer diameter, is inserted into another tube 11, which has a larger outer diameter (e.g. evaporator suction tube). Then, the coupling portions of both tubes 10 and 11 are welded and connected to each other by using filler metal 12. However, this configuration has a problem in that, if there are errors between the outer diameter of the capillary tube 10 and the inner diameter of the other tube 11, or if an inexperienced operator causes poor welding, both tubes 10 and 11 may not be welded completely and cause the refrigerant to leak out, as shown in FIG. 1b. Furthermore, in some cases, the filler metal 12 may flow into the other tube 11 and clog the capillary tube.

Meanwhile, copper tubes are widely used as the piping of general air conditioners. The above-mentioned problem still exists when copper tubes are connected to each other.

Therefore, it has been requested to provide technology for avoiding the above-mentioned problem when interconnecting capillary tubes having a smaller diameter or other types of copper tubes or copper-alloy tubes for refrigeration devices or air conditioners. Hereinafter, capillary tubes, copper tubes and copper-alloy tubes used for aforementioned connecting purposes are referred to as copper tubes as a whole.

### SUMMARY OF THE INVENTION

Accordingly, the present invention has been made to solve the above-mentioned problems occurring in the prior art, and the present invention provides a copper tube connecting apparatus adapted to facilitate a welding operation when a copper tube is connected to another tube regardless of the diameter of both tubes and the degree of skill of the operator, reduce the rate of poor welding, and prevent the copper tube from clogging or the refrigerant from leaking through the welded portion due to poor welding, as a method for connecting copper tubes by using the tube connecting apparatus.

The present invention also provides a copper connecting apparatus adapted to facilitate a welding operation when a copper tube is connected to another tube regardless of the degree of skill of the operator, enable the operator to easily locate the inserted filler metal and recognize the accurate heating position, and guarantee rapid transfer of heat to the filler metal, as well as a method for connecting copper tubes by using the tube connecting apparatus.

The present invention also provides a copper connecting apparatus adapted to inform the operator of a suitable welding heating time when a copper tube is connected to another tube so that reliable welding is guaranteed regardless of the degree of skill of the operator, as well as a method for connecting copper tubes by using the copper tube connecting apparatus.

In accordance with an aspect of the present invention, there is provided a copper tube connecting apparatus including a body; a copper tube insertion hole formed on a first end of the body; and a connector hole formed to connect the copper tube insertion hole to a second tube insertion hole, wherein both ends of the connector hole have a diameter smaller than corresponding diameters of the copper tube insertion hole and the second tube insertion hole.

The end of the connector hole near the copper tube insertion hole has a diameter smaller than the corresponding diameter of the copper tube insertion hole so that the resulting difference in diameter creates a stopping step between the connector hole and the copper tube insertion hole, and the end of the connector hole near the second tube insertion hole has a diameter smaller than the corresponding diameter of the second tube insertion hole so that the resulting difference in diameter creates a stopping step between the connector hole and the second tube insertion hole. Alternatively, the end of the connector hole near the second tube insertion hole has a diameter smaller than the corresponding diameter of the second tube insertion hole so that the resulting difference in diameter creates a stopping step between the connector hole and the second tube insertion hole, and the end of the connector hole near the copper tube insertion hole has a protrusion-type stopping step formed thereon.

The copper tube connecting apparatus further includes a first filler metal receiving groove formed on the first end of the body, the copper tube insertion hole being formed on the first end, so as to surround the copper tube insertion hole; a second filler metal receiving groove formed on the second end of the body, the second tube insertion hole being formed on the second body, so as to surround the second tube insertion hole; and hollow filler metals mounted in the first and second filler metal receiving grooves, respectively.

Preferably, the body of the copper tube connecting apparatus is formed as a hollow metallic cylinder, and the copper tube insertion hole, the second tube insertion hole, and the connector hole are formed coaxially.

Preferably, the first filler metal receiving groove protrudes outward from the first end of the body, the copper tube insertion hole being formed on the first end, and the second filler metal receiving groove protrudes outward from the second end of the body, the second tube insertion hole being formed on the second end. The first and second filler metal receiving grooves are displaced inward from both ends of the body by a predetermined distance L, respectively.

In accordance with another aspect of the present invention, there is provided a copper tube connecting apparatus including a body; a copper tube insertion hole formed on a first end of the body; a second tube insertion hole formed on a second end of the body; a connector hole formed to connect the copper tube insertion hole to the second tube insertion hole; a first filler metal receiving groove formed on the first end of the body, the copper tube insertion hole being formed on the first end, so as to surround the copper tube insertion hole; a second filler metal receiving groove formed on the second end of the body, the second tube insertion hole being formed on the second end, so as to surround the second tube insertion hole; at least one first through-hole extending through the first end of the body to the first filler metal receiving groove; and at least one second through-hole extending through the second end of the body to the second filler metal receiving groove.

The first and second through-holes extend in a radial direction from the first and second filler metal receiving grooves to an outer surface of the body, respectively.

Both ends of the connector hole have a diameter smaller than corresponding diameters of the copper tube insertion hole and the second tube insertion hole. The end of the connector hole near the copper tube insertion hole has a protrusion-type stopping step formed thereon, and the end of the connector hole near the second tube insertion hole has a diameter smaller than the corresponding diameter of the second tube insertion hole so that the resulting difference in diameter creates a stopping step between the connector hole and the second tube insertion hole.

Preferably, the first filler metal receiving groove protrudes outward from the first end of the body, the copper tube insertion hole being formed on the first end, and the second filler metal receiving groove protrudes outward from the second end of the body, the second tube insertion hole being formed on the second end. The first and second filler metal receiving grooves are displaced inward from both ends of the body by a predetermined distance L, respectively.

In accordance with another aspect of the present invention, there is provided a method for connecting copper tubes by using a copper tube connecting apparatus having the above-mentioned features, the method including the steps of inserting the copper tube and the second tube into the copper tube insertion hole and the second tube insertion hole, respectively; moving the copper tube and the second tube to both ends of the connector hole, respectively; and heating the first and second ends of the body, the first and second filler metal receiving grooves being formed on the first and second ends of the body, respectively, to melt the first and second filler metal and conduct welding.

When through-holes have been formed, the method further includes a step of determining whether or not heating is appropriate with reference to conditions of the melted first and second filler metals flowing out through the first and second through-holes.

### BRIEF DESCRIPTION OF THE DRAWINGS

FIGS. 1a and 1b illustrate a method for connecting copper tubes according to the prior art.

FIG. 2 shows the construction of a copper tube connecting apparatus according to a first embodiment of the present invention.

FIG. 3 illustrates the operation of the copper tube connecting apparatus according to the first embodiment of the present invention.

FIG. 4 shows the construction of a copper tube connecting apparatus according to a second embodiment of the present invention.

FIG. 5 is a longitudinal sectional view of the copper tube connecting apparatus according to the second embodiment of the present invention.

FIG. 6 shows the construction of a copper tube connecting apparatus according to a third embodiment of the present invention.

FIG. 7 shows the construction of a copper tube connecting apparatus according to a fourth embodiment of the present invention.

FIG. 8 shows the construction of a copper tube connecting apparatus according to a fifth embodiment of the present invention.

FIG. 9 shows the construction of a copper tube connecting apparatus according to a sixth embodiment of the present invention.

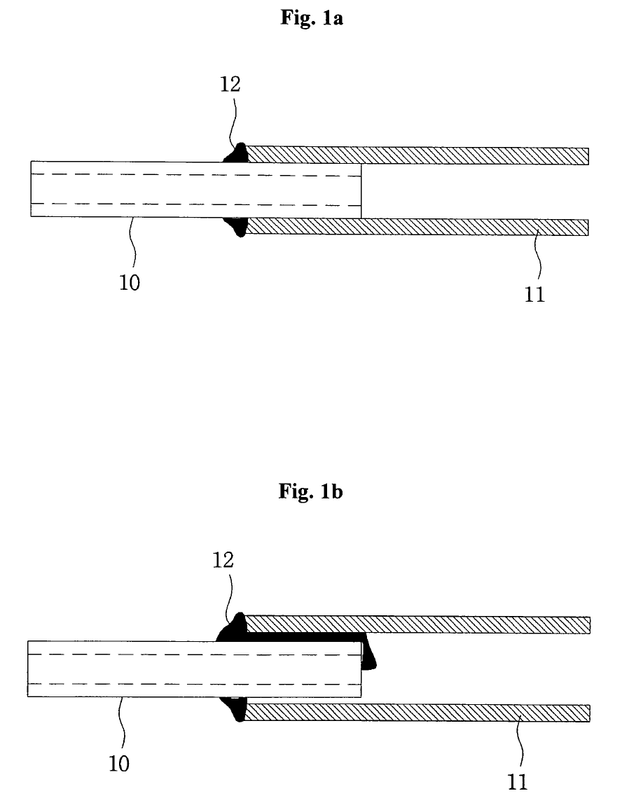

### DESCRIPTION OF THE PREFERRED EMBODIMENTS

Hereinafter, an exemplary embodiment of the present invention will be described with reference to the accompanying drawings. In the following description and drawings, the same reference numerals are used to designate the same or similar components, and so repetition of the description on the same or similar components will be omitted.

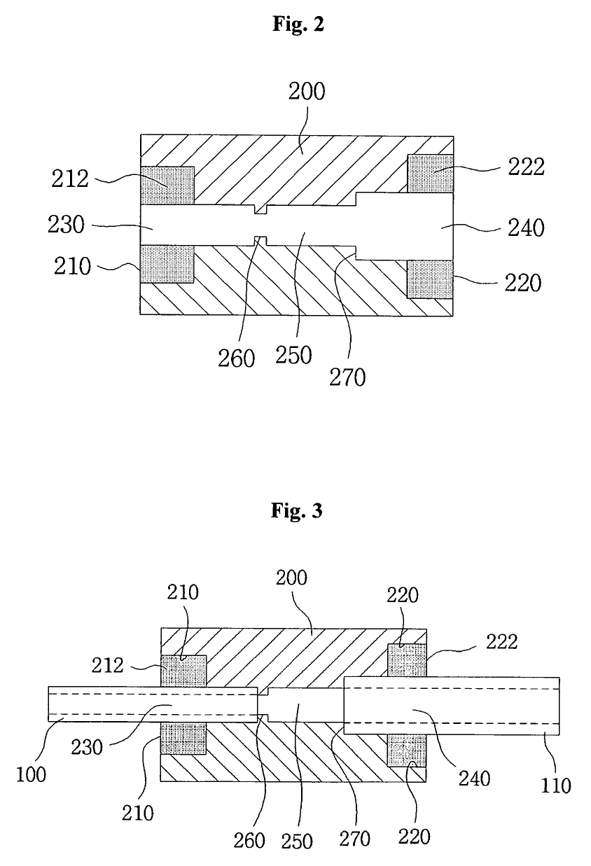

FIG. 2 shows the construction of a copper tube connecting apparatus according to a first embodiment of the present invention, and FIG. 3 illustrates the operation of the copper tube connecting apparatus according to the first embodiment of the present invention.

Referring to FIG. 2, the copper tube connecting apparatus includes a hollow body 200, which has a hollow portion so that a copper tube can be inserted therein; a copper tube insertion hole 230, which has a first diameter corresponding to the diameter of a copper tube 100, formed on the first end of the body 200; a second tube insertion hole 240, which has a second diameter corresponding to the diameter of a second tube 110 to be connected to the copper tube 100, formed on the second end of the body 200; and a connector hole 250 formed between the copper tube insertion hole 230 and the second tube insertion hole 240 so that both tubes 230 and 240 communication with each other. As such, the connector hole 250 defines a hollow portion inside the copper tube connecting apparatus. As an alternative to the construction shown in FIG. 2, the copper tube insertion hole 230 and the second tube insertion hole 240 may have different diameters.

A protrusion-type first stopping step 260 is formed between the inner end of the copper tube insertion hole 230 and one end of the connector hole 250, and indicates the limit of insertion of the copper tube 100. In addition, the difference in diameter between the second tube insertion hole 240 and the connector hole 250 creates a second stopping step 270 between the inner end of the second tube insertion hole 240 and the other end of the connector hole 250, and the second stopping step 270 indicates the limit of insertion of the second tube 110. The protrusion-type first stopping step 260 preferably has a minimum size so that it does not interfere with the flow of fluid between the copper tube 100 and the connector hole 250. The diameter of the connector hole 250 must have a value between the first diameter of the copper tube insertion hole 230 and the second diameter of the second tube insertion hole 240. The connector hole 250 is shown in FIG. 2 to have a diameter equal to the first diameter of the copper tube insertion hole 230.

The body 200 has a first filler metal receiving groove 210 formed on the first end, on which the copper tube insertion hole 230 is formed, so as to surround the copper tube insertion hole 230. Furthermore, the body 200 has a second filler metal receiving groove 220 formed on the second end, on which the second tube insertion hole 240 is formed, so as to surround the second tube insertion hole 240. As a result, hollow (or ring-shaped) first and second filler metal 212 and 222 can be mounted in the first and second filler metal receiving grooves 210 and 220, respectively.

The copper tube connecting apparatus of the above-mentioned structure is used to connect the copper tube 100 to the second tube 110 in the following manner: the copper tube 100 is inserted until it is stopped by the first stopping step 260 on the inner end of the copper tube insertion hole 230, and the second tube 110 is inserted until it is stopped by the second stopping step 270 on the inner end of the second tube insertion hole 240. A heating device (e.g. torch) is used to heat both ends of the body 200 so that the filler metals 212 and 222 on both ends melt. As a result, the copper tube 100 and the second tube 110 are welded to the body 200, respectively.

Particularly, heating of the ends of the body 200 melts the second filler metal 222, which then flows between the inner surface of the body 200 and the outer surface of the second tube 110 during the course of welding. The contact between the end of the second tube 110 and the second stopping step 270 formed on the inner end of the second tube insertion hole 240 prevents the second filler metal 222 from proceeding further. This avoids any possibility that the second filler metal 222 may clog the interior of the second tube 110. In the case of the welding region where the body 200 of the copper tube connecting apparatus, the copper tube 100, and the first filler metal 212 join one another, the contact between the end of the copper tube 110 and the first stopping step 260 formed on the inner end of the copper tube insertion hole 230 similarly prevents the first filler metal 212 from proceeding further. This avoids any possibility that the first filler metal 212 may clog the interior of the copper tube 100.

The body 200 of the copper tube connecting apparatus preferably has a cylindrical shape, and is made of a metallic material (e.g. copper, copper alloy), but the shape and material of the body 200 may be varied as desired without limiting the scope of the present invention. In addition, those skilled in the art can easily understand that, although it has been assumed in the above description of an embodiment of the present invention that the copper tube insertion hole 230, the second tube insertion hole 240, and the connector hole 250 are coaxially formed, the copper tube insertion hole 230 and the second tube insertion hole 240 may be formed on different axes and then connected to each other via the connector hole 250. This can also be said with regard to the following descriptions of other embodiments of the present invention.

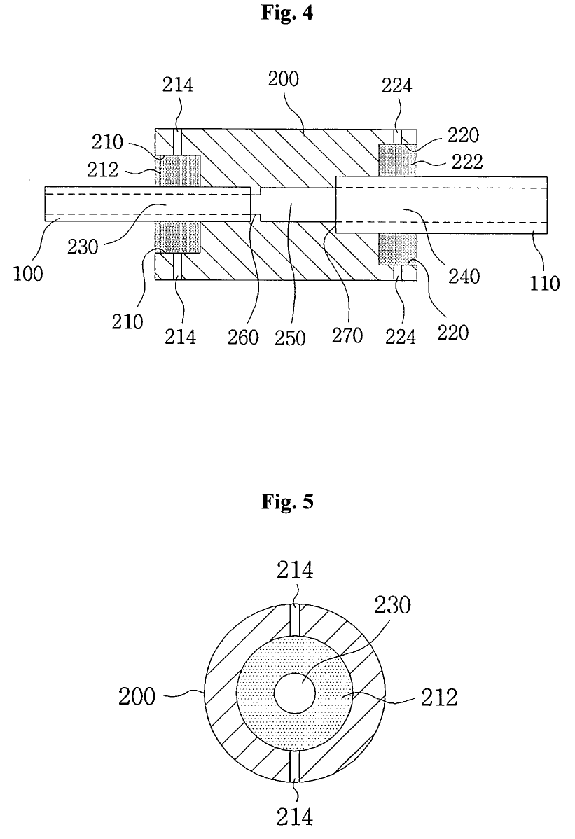

FIG. 4 shows the construction of a copper tube connecting apparatus according to a second embodiment of the present invention.

The overall construction of the copper tube connecting apparatus according to the second embodiment is the same as that according to the first embodiment, except for through-holes for allowing the filler metal to leak. Particularly, the copper tube connecting apparatus according to the second embodiment is characterized in that it includes at least one first through-hole extending through the first end of the body of the apparatus to a first filler metal receiving groove, and at least one second through-hole extending through the second end of the body to the second filler metal receiving groove. The first and second through-holes extend in the radial direction from the first and second filler metal receiving grooves to the outer surface of the body.

The copper tube connecting apparatus according to the second embodiment will be described in more detail with reference to FIG. 4. The apparatus has at least one, preferably two, through-holes formed between the outer surface of the body 200 and the inner surface of the first and second filler metal receiving grooves 212 and 222, respectively. FIG. 4 shows two first through-holes 214 extending from the outer surface of the first end of the body 200 to the inner surface of the first filler metal receiving groove 212 upward and downward, respectively, and two second through-holes 224 extending from the outer surface of the second end of the body 200 to the inner surface of the second filler metal receiving groove 222 upward and downward, respectively. Those skilled in the art can understand that more than two through-holes may be formed for each end of the body 200.

FIG. 5 is a longitudinal sectional view of the copper tube connecting apparatus according to the second embodiment of the present invention, and shows two through-holes 212 formed on the first end of the body 200 of the apparatus upward and downward, respectively.

When the copper tube connecting apparatus is used to connect copper tubes, both ends of the body 200 of the apparatus are heated to melt the filler metals 212 and 222, which then flow out of the body 200 through the first and second through-holes 214 and 224 formed on both ends of the body 200 due to the capillary phenomenon. This makes it possible to determine whether heating suitable or optimized for welding is being conducted with reference to conditions of the filler metals 212 and 222 flowing out through the through-holes 212 and 224.

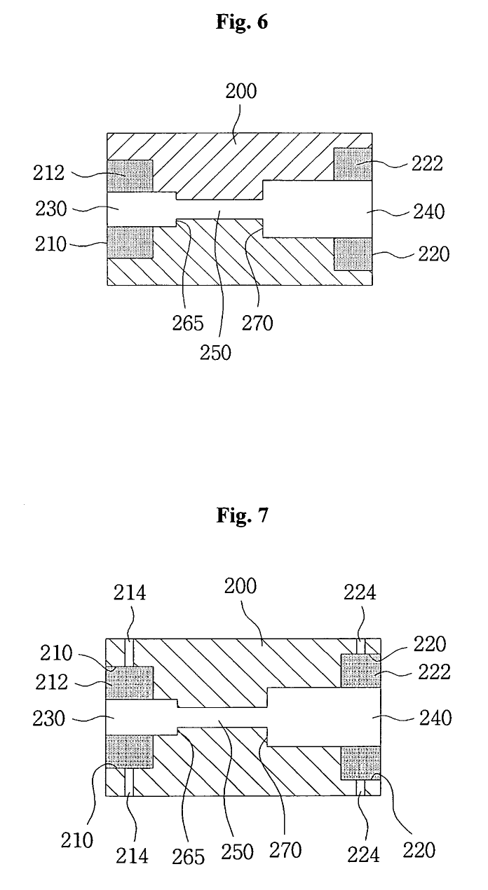

FIG. 6 shows the construction of a copper tube connecting apparatus according to a third embodiment of the present invention.

The construction of the copper tube connecting apparatus according to the third embodiment of the present is the same as that according to the first embodiment, except that the first stopping step 265 has the shape of a stepped portion exactly like the second stopping step 270.

Particularly, the diameter of both ends of the connector hole 250 of the copper tube connecting apparatus shown in FIG. 6 may have any value smaller than the first diameter of the copper tube insertion hole 230 and the second diameter of the second tube insertion hole 240. In other words, the entire connector hole 250 need not have the same diameter, and both ends of the connector hole 250 may have different diameters, as long as the size and shape of the connector hole 250 do not interfere with the flow of fluid between the copper tube 100 and the second tube 110.

The method for connecting the copper tube 100 to the second tube 110 according to the third embodiment is the same as in the first embodiment.

FIG. 7 shows the construction of a copper tube connecting apparatus according to a fourth embodiment of the present invention.

The copper tube connecting apparatus shown in FIG. 7 combines the characteristics of the third embodiment (i.e. the first stopping step 265 has the shape of a stepped portion exactly like the second stopping step 270) with those of the second embodiment (i.e. through-holes 214 and 224 for allowing filler metals 212 and 222 to leak). The remaining components and the connecting method will be obvious to those skilled in the art, and detailed description thereof will be omitted herein.

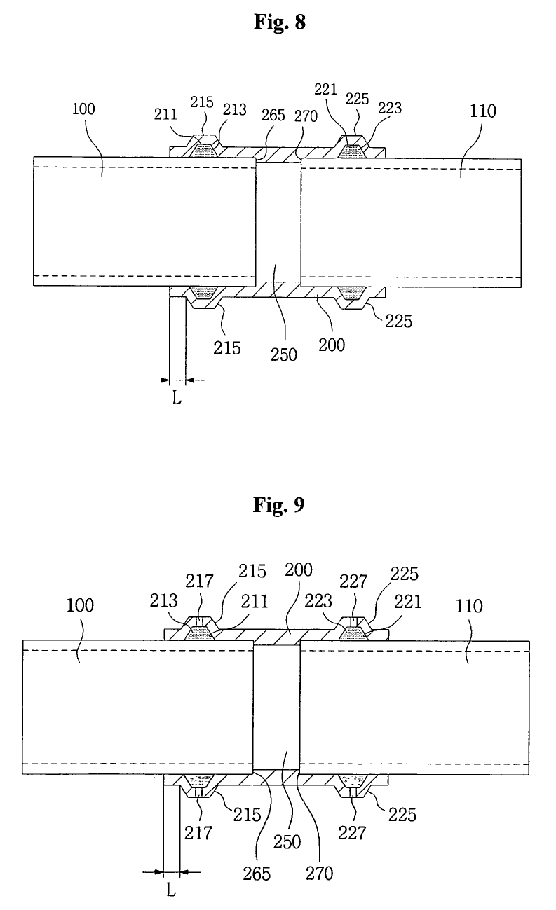

FIG. 8 shows the construction of a copper tube connecting apparatus according to a fifth embodiment of the present invention.

Referring to FIG. 8, the apparatus has a first filler metal receiving groove 211 protruding outward from the first end of the body 200, on which the copper tube insertion hole 230 is formed, and a second filler metal receiving groove 221 protruding outward from the second end, on which the second tube insertion hole 240 is formed, so that hollow filler metals 213 and 223 can be mounted in a shape corresponding to that of the filler metal receiving grooves 211 and 221.

Therefore, the body 200 of the copper tube connecting apparatus has protrusions, particularly filler metal receiving groove protrusions 215 and 225, in regions where the first and second filler metal receiving grooves 211 and 221 are formed. The filler metal receiving groove protrusions 215 and 225 must be shaped to increase the heat transfer area as much as possible so that heat applied to the copper tube is quickly transmitted to the filler metals 213 and 223 via the surface of the copper tube. Preferably, the filler metal receiving groove protrusions 215 and 225 have an approximately V-shaped or U-shaped sectional structure.

Although the first and second filler metal receiving grooves 211 and 221 are shown in FIG. 8 to be displaced inward from both ends of the body by a predetermined distance L, the position is not limited to that. Ring-shaped welding rods may be used as the first and second filler metals 213 and 223, which may be inserted either during or after the process of forging the copper tube.

A process of connecting copper tubes by using the copper tube connecting apparatus, which has the above-mentioned construction, as well as its operation, will now be described with reference to FIG. 8, which is a sectional view showing a state after insertion of the copper tube.

Referring to FIG. 8, the copper tube connecting apparatus according to the fifth embodiment of the present invention is used to connect two copper tubes 100 and 110 in the following manner: the first copper tube 100 is inserted until it is stopped by the stopping step 265 on the inner end of the copper tube insertion hole 230, and the second copper tube 110 is inserted until it is stopped by the stopping step 270 on the inner end of the second tube insertion hole 240. Then, a heating device (e.g. torch, high-frequency heater) is used to heat the filler metal receiving groove protrusions 215 and 225 on both ends of the body 200 so that filler metals 213 and 223 on both ends are melted. The copper tube 100, the copper tube connecting apparatus body 200, and the second copper tube 110 are welded to one another in this manner.

By using the copper tube connecting apparatus, the position of inserted filler metal is easily recognized from the filler metal receiving groove protrusions 215 and 225 of the body 200 of the apparatus, and the heating position is accurately grasped. This facilitates the welding process regardless of the degree of skill of the operator. In addition, the filler metal receiving groove protrusions 215 and 225 correspond to radial extensions of the body 200 of the copper tube connecting apparatus. This means that the surface area is increased both locally and globally, and that the substantial heat transfer area is enlarged.

Therefore, heat applied to the filler metal receiving groove protrusions 215 and 225 with an enlarged heat transfer area is quickly transferred to the filler metals 213 and 223 via the surface of the copper tube. This guarantees an accurate welding operation and prevents poor welding.

Although it has been assumed with reference to FIG. 8 that the thickness of the solid portion of the copper tube connecting apparatus varies in the axial direction (i.e. the thickness of the solid portion of the connector hole differs from that of other parts), the entire solid portion of the copper tube may have the same thickness. Particularly, the copper tube connecting apparatus may be processed along the axial direction by forging or pressing so that respective parts are enlarged and reduced while the entire solid portion retains the same thickness. As a result, the copper tube is stopped by the central, enlarged part and is inserted no longer. This replaces the stopping steps 265 and 270 according to the above-mentioned embodiments.

FIG. 9 shows the construction of a copper tube connecting apparatus according to a sixth embodiment of the present invention.

The construction of the copper tube connecting apparatus according to the sixth embodiment is the same as that according to the fifth embodiment shown in FIG. 8, except that additional through-holes 217 and 227 for allowing the filler metals 213 and 223 to leak are provided. Therefore, the structural characteristics and the operating method will be obvious to those skilled in the art, and detailed description thereof will be omitted herein.

As mentioned above, the copper tube connecting apparatus and the method for connecting copper tubes by using the tube connecting apparatus according to the present invention have the following advantages: when a copper tube is connected to another tube, the welding process is made easy regardless of the diameter of both tubes and the degree of skill of the operator; and the rate of poor welding is reduced to prevent the copper tube from clogging or the refrigerant from leaking through the welded portion due to poor welding.

In addition, when a copper tube is connected to another tube, the welding operation is made easy regardless of the degree of skill of the operator, and the operator can easily locate the inserted filler metals and recognize the accurate heating position. This guarantees rapid transfer of heat to the filler metal.

The apparatus and method inform the operator of a suitable welding heating time when a copper tube is connected to another tube so that reliable welding is guaranteed regardless of the degree of skill of the operator.

Furthermore, the apparatus and method enable the operator to accurately control the heating position and heating time when copper tubes are connected. This avoids incomplete welding due to insufficient heating time and prevents the copper tubes or the copper tube connecting apparatus from deforming due to excessive heating. As a result, the rate of poor welding decreases.

The apparatus and method can also prevent the operating fluid (e.g. refrigerant, water) of a refrigeration device or an air conditioner from leaking due to poor welding. This improves the reliability of the refrigeration device or the air conditioner.

Although an exemplary embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. An apparatus for connecting copper tube comprising:
a body,
a copper tube insertion hole formed on a first end of the body, and
a connector hole formed to connect the copper tube insertion hole to a second tube insertion hole, wherein both ends of the connector hole have a diameter smaller than corresponding diameters of the copper tube insertion hole and the second tube insertion hole.

2. The apparatus as claimed in claim 1, wherein the end of the connector hole near the copper tube insertion hole has a diameter smaller than the corresponding diameter of the copper tube insertion hole so that the resulting difference in diameter creates a stopping step between the connector hole and the copper tube insertion hole, and the end of the connector hole near the second tube insertion hole has a diameter smaller than the corresponding diameter of the second tube insertion hole so that the resulting difference in diameter creates a stopping step between the connector hole and the second tube insertion hole.

3. The apparatus as claimed in claim 1, wherein the end of the connector hole near the second tube insertion hole has a diameter smaller than the corresponding diameter of the second tube insertion hole so that the resulting difference in diameter creates a stopping step between the connector hole and the second tube insertion hole, and the end of the connector hole near the copper tube insertion hole has a protrusion-type stopping step formed thereon.

4. The apparatus as claimed in claim 2, further comprising a first filler metal receiving groove formed on the first end of the body, the copper tube insertion hole being formed on the first end, so as to surround the copper tube insertion hole, a second filler metal receiving groove formed on the second end of the body, the second tube insertion hole being formed on the second body, so as to surround the second tube insertion hole, and hollow filler metals mounted in the first and second filler metal receiving grooves, respectively.

5. The apparatus as claimed in claim 4, wherein the body is formed as a hollow metallic cylinder, and the copper tube insertion hole, the second tube insertion hole, and the connector hole are formed coaxially.

6. The apparatus as claimed in claim 4, wherein the first filler metal receiving groove protrudes outward from the first end of the body, the copper tube insertion hole being formed on the first end, and the second filler metal receiving groove protrudes outward from the second end of the body, the second tube insertion hole being formed on the second end.

7. The apparatus as claimed in claim 6, wherein the first and second filler metal receiving grooves are displaced inward from both ends of the body by a predetermined distance L, respectively.

8. An apparatus for connecting copper tube comprising:
a body,
a copper tube insertion hole formed on a first end of the body,
a second tube insertion hole formed on a second end of the body,
a connector hole formed to connect the copper tube insertion hole to the second tube insertion hole,
a first filler metal receiving groove formed on the first end of the body, the copper tube insertion hole being formed on the first end, so as to surround the copper tube insertion hole,
a second filler metal receiving groove formed on the second end of the body, the second tube insertion hole being formed on the second end, so as to surround the second tube insertion hole,
at least one first through-hole extending through the first end of the body to the first filler metal receiving groove, and
at least one second through-hole extending through the second end of the body to the second filler metal receiving groove.

9. The apparatus as claimed in claim 8, wherein the first and second through-holes extend in a radial direction from the first and second filler metal receiving grooves to an outer surface of the body, respectively.

10. The apparatus as claimed in claim 9, wherein both ends of the connector hole have a diameter smaller than corresponding diameters of the copper tube insertion hole and the second tube insertion hole.

11. The apparatus as claimed in claim 10, wherein the end of the connector hole near the copper tube insertion hole has a protrusion-type stopping step formed thereon, and the end of the connector hole near the second tube insertion hole has a diameter smaller than the corresponding diameter of the second tube insertion hole so that the resulting difference in diameter creates a stopping step between the connector hole and the second tube insertion hole.

12. The apparatus as claimed in claim 10, wherein the first filler metal receiving groove protrudes outward from the first end of the body, the copper tube insertion hole being formed on the first end, and the second filler metal receiving groove protrudes outward from the second end of the body, the second tube insertion hole being formed on the second end.

13. The apparatus as claimed in claim 10, wherein the first and second filler metal receiving grooves are displaced inward from both ends of the body by a predetermined distance L, respectively.

14. The apparatus as claimed in one of claim 8, further comprising hollow filler metals mounted in the first and second filler metal receiving grooves, respectively.

15. A method for connecting copper tubes, the method comprising the steps of:
inserting the copper tube and the second tube into the copper tube insertion hole and the second tube insertion hole, respectively,
moving the copper tube and the second tube to both ends of the connector hole, respectively, and
heating the first and second ends of the body, the first and second filler metal receiving grooves being formed on the first and second ends of the body, respectively, to melt the first and second filler metal and conduct welding.

16. The method as claimed in claim 15, further comprising a step of determining whether heating is appropriate with reference to conditions of the melted first and second filler metals flowing out through the first and second through-holes.
